(19) United States
(12) Patent Application Publication
(10) Pub. No.: US 2008/0306853 A1
(43) Pub. Date: Dec. 11, 2008

(54) System and Apparatus for Bidding

(76) Inventors: Greg McLemore, Hermosa Beach, CA (US); Adam Jackson, San Francisco, CA (US)

Correspondence Address: Oppedahl Patent Law Firm LLC, P.O. BOX 4850, FRISCO, CO, 80443-4850, US

(21) Appl. No.: 10/597,562

(22) PCT Filed:
(86) PCT No.: PCT/IB05/50113

(51) Int. Cl. G06Q 40/00

(52) U.S. Cl. 705/37

(57) ABSTRACT

In connection with a computer-based auction system, the auction system communicatively coupled with sellers and bidders, the system having records indicative of sellers of items and records indicative of bidders for the items and identifying for each item a winning bidder in an auction, a first bidder selects a first item for which there is a winning bidder who is not the same as the first bidder. By electronic means, information is obtained indicative of identities of second bidders other than the first bidder who previously placed respective bids for the first item. Second items are found other than the first item for which bids have been placed by one or more of the second bidders. A second item is chosen by the first bidder, for which the first bidder was not aware of the second item until after the auction ended. The first bidder then attempts to discern why the first bidder was not aware of the second item until after the auction ended. Alternatively this approach is used to identifying a second item for which the auction has not yet ended, and the first bidder places a bid higher than any bids previously placed for that second item.

### CROSS-REFERENCE TO RELATED APPLICATIONS

This application is a non-provisional of U.S. application No. 60/535,437 filed Jan. 8, 2004, which application is incorporated herein by reference for all purposes.

### BACKGROUND

Auctions have been around for millennia.

Until very recent times, all auctions have been conducted in vivo; bidders or their agents are required to be physically in the same room for the auction to take place. Each would-be bidder is either in the room (or is in communication with an agent in the room) or is not in the room (and has no agent in the room). If the bidder (or the bidder's agent) is in the room, then the bidder is instantly and continuously aware of the fact that the auction is taking place. It is unlikely or perhaps impossible, for the bidder who is in the room to be unaware that an auction of a particular item is taking place. On the other hand, if the bidder is not in the room (and has no agent in the room) then the bidder is by definition unaware of what is being auctioned.

Books, movies, and television have all portrayed such auctions, from raucous slave auctions in ancient Rome to polite art auctions at Christie's and Sotheby's where well-dressed bidders indicate bids by raising numbered paddles, with some bids communicated by telephone to and from bidders who are geographically distant from the auction house. Retailers of urban legends like to describe livestock auctions where bids are indicated by subtle gestures and nods, and where a newcomer might, by scratching an itch, unknowingly purchase a cow or horse, then (so goes the urban legend) by some other unwitting action, resell the cow or horse at a profit.

Books, movies, and television have likewise portrayed stock and commodities exchanges having a “trading pit” where brokers shout out orders and where slips of paper serve to memorialize matches between buyer and seller. Historically the physical limitation on the size of the trading pit puts a natural upper bound on the number of participants that can fit in the room, and this has led to a limit of the number of “seats” at the exchange. A would-be buyer or seller is forced to go through a broker rather than to participate directly in the trading activity.

Technology has slowly crept into auctions and into exchanges, many of which are carried out in silico rather than in vivo. Some stock exchanges are now largely electronic, and some of them do not even have a “trading pit.” Perhaps best known of the electronic auction systems is eBay. With eBay, there is no requirement that the bidders all be in the same geographic location. Advances in computer networking and telecommunications (chief among them the rise and penetration of the Internet into society and commerce) have reduced the need to trade or bid through an agent or broker, and have vastly increased the number of participants capable of participating. Few would consider it an overstatement to say that the world of auctions has been transformed in kind, and not merely in degree, by the advent of eBay and other automated auction systems.

But experience with contemporary automated auction systems soon leads to a realization that it is not easily within grasp for a would-be bidder to be confident of bidding optimally in a given auction system. A few examples will suffice to illustrate this problem, and those experienced in the art will have no difficulty recounting experiences of their own to highlight this problem.

As one example, there is the problem of simply learning that a desired item is available for auction.

In a classic Christie's or Sotheby's auction, the would-be bidder is either present in the auction room (directly or through a proxy) or is not. If the would-be bidder is not present, then the would-be bidder will stand no chance of winning bids, but this simply follows automatically from the fact of not being present at the auction. To the extent there is some missed opportunity to bid, the would be bidder who has failed to attend will not feel that the system has filed him or her, as the problem could have been readily cured simply by showing up for the auction. On the other hand, if the would-be bidder is present in the room, then it is easy enough to keep track of every single item being auctioned, as the auctions take place seriatim.

But in a contemporary online auction, there can be a million or more items all being auctioned simultaneously. Quite simply it is not humanly possible to follow all items being auctioned and to be confident of bidding optimally as to all items for which one would desire to bid.

In this world of online auctions, the would-be bidder will select among the millions of pending auctions and will bid on only a few of the items. For a system such as eBay, the selection process tends to follow two main paths.

First, a would-be bidder can “drill down” through a classification system. For example a would-be bidder may start in “Computers & Networking” and then narrow the search to “Networking,” then to “Wireless Networking,”, then to “WiFi,” then to “PC Cards,”, then to “USB, Adapters, NICs,”, and finally to “PC Cards, PCMCIA (Laptop),”, in a numerical classification (in the case of eBay) of 45000. Having done this, the would-be bidder can return again and again to the numerical class and can review the pending items for auction which are in this class, perhaps bidding for one or more such items.

Second, a would-be bidder can search, looking for particular words or phrases in the titles or titles and descriptions of pending auctions. This may yield a list of items matching the search terms, and the would-be bidder can review the pending items, perhaps bidding for one or more such items.

Experienced would-be bidders can vary their approaches, for example using a mix of search terms and numerical classes to narrow down the field of items upon which bids may be made. A variety of other search approaches may be used as well.

It will be appreciated, however, that these and most other searching approaches rely in a fundamental way on behavior and decisions of persons whom one does not know and has not met. Such sellers may make classification decisions that are, from the point of view of the would-be bidder, irrational or inscrutable. Likewise such sellers may choose vocabulary in titles or descriptions that differs from the vocabulary that the would-be bidder would have expected to see used. The allocation of key words (by the seller) between the “title” and “description” fields may also turn out to be different from what the would-be bidder would have expected. Stated in a somewhat colorful and figurative way, the would-be bidder who is going to depend (for a successful search) upon classification and description decisions by unknown sellers is relying upon the kindness of strangers. Experience shows that such reliance is not always well placed.

Yet another aspect of the problem is that it will sometimes turn out that a seller may not even appreciate what there is about an item that would be of interest to a bidder. For example an antique photograph may show a particular item in the corner, and the bidder may be interested in the photograph because of the item in the corner. Searching on a textual description of the item may not reveal this reason for interest, and looking at classifications (categories) may likewise not reveal it. It would be very helpful if methods and apparatus could be devised which would help to find such items.

Among those would-be bidders who take seriously a goal of being thorough and bidding optimally, however, many experiences make it easy to learn of missed opportunities. A would-be bidder can search “closed items,” that is, items for which the bidding has ended and for which a winning bidder has been identified. Such a search is generally carried out just as described above, for example, through numerical classes or word searches or a combination of both, and identifies items which the would-be bidder missed.

Yet other missed opportunities may arise for which the would-be bidder never even learns that there was a missed opportunity. The same key word or classification search that failed to identify an item during the time it was being auctioned will, likely enough, fail to identify it later when one searches closed items.

It should be appreciated that classic in-person auctions never really present these problems. If the bidder was in the room, the bidder could not help but learn of each item as it came up to be auctioned. If the bidder chose not to attend the auction, then it was that decision (and not any feared inattention or failure to search well enough) that led to the failure to win the bidding.

Those skilled in the art will readily appreciate that real money is at stake. The would-be bidder who fails to learn that some item could have been purchased for, say, $80,000 and who instead is forced to bid $100,000 for some other comparable item has spent an extra $20,000 unnecessarily. Likewise the enjoyment to be derived from an item once purchased can have immeasurable value; the would-be bidder who fails to learn that some item can be purchased presently, and who is instead forced to wait some weeks until a comparable item comes up for bid, has needlessly forgone such enjoyment for those weeks. Finally if an item is unique, later items may be of no consolation.

Patents and publications mentioning auctions and exchanges include US 2004/0267731 entitled “Method and system to facilitate building and using a search database,” US 2004/0193525 entitled “Online bidding system and method of the same,” US 2002/0082977 entitled “Aggregation of on-line auction listing and market data for use to increase likely revenues from auction listings,” U.S. Pat. No. 6,732,161 entitled “Information presentation and management in an online trading environment,” U.S. Pat. No. 6,058,417 entitled “Information presentation and management in an online trading environment,” U.S. Pat. No. 6,044,363 entitled “Automatic auction method,” U.S. Pat. No. 6,012,045 entitled “Computer-based electronic bid, auction and sale system, and a system to teach new/non-registered customers how bidding, auction purchasing works,” US 2002/0023037 entitled “Exchange method and apparatus,” and international patent publication WO 00/62225 entitled “Marketplace system fees enhancing market share and participation.”

Despite these great needs, and despite many attempts to address these needs, there has until the present time been no truly new approach to these needs. Approaches proposed until now have been merely incremental in their advance (e.g. applying a thesaurus to the search terms) and it would be helpful if wholly new approaches could be found.

### SUMMARY OF THE INVENTION

In connection with a computer-based auction system, the auction system communicatively coupled with sellers and bidders, the system having records indicative of sellers of items and records indicative of bidders for the items and identifying for each item a winning bidder in an auction, a first bidder selects a first item. By electronic means, information is obtained indicative of identities of second bidders other than the first bidder who previously placed respective bids for the first item. Second items are found other than the first item for which bids have been placed by one or more of the second bidders. A second item is chosen by the first bidder, for which the first bidder was not aware of the second item until after this work is done. The first bidder may then attempt to discern why the first bidder was not aware of the second item until after the auction ended. Alternatively this approach is used to identifying a second item for which the auction has not yet ended, and the first bidder places a bid higher than any bids previously placed for that second item.

### DESCRIPTION OF THE DRAWING

The invention will be described with respect to a drawing in several figures.

FIG. 1 shows in functional block diagram form a typical online auction system, together with apparatus 22 according to the invention.

FIG. 2 shows apparatus 22 of FIG. 1 in greater detail, in functional block diagram form.

FIG. 3 shows in flowchart form a first method according to the invention.

FIG. 4 shows in flowchart form a second method according to the invention.

FIG. 5 depicts relationships among various data records in the system according to the invention.

FIG. 6 shows a user interface flowchart for apparatus according to the invention.

### DETAILED DESCRIPTION

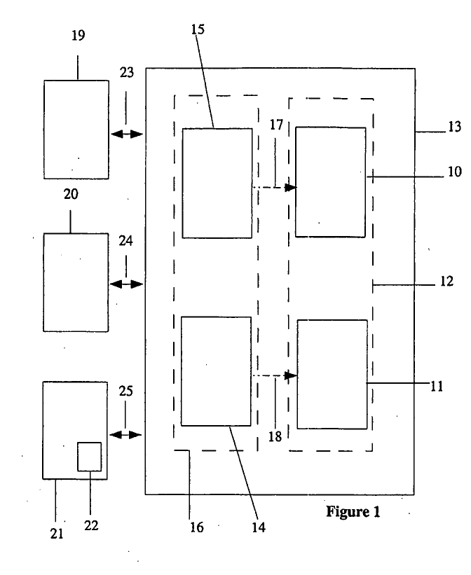

FIG. 1 shows in functional block diagram form a typical online auction system 13, together with apparatus 22 according to the invention. Online auction system 13 may be seen, which is communicatively coupled (e.g. by the Internet through web-based interfaces) with sellers 19 and bidders 20 through links 23 and 24 respectively. In an exemplary embodiment (e.g. eBay) there is a database 15 of sellers, a database 14 of bidders, a database 10 of items being auctioned, and a database 11 of bids placed for the items being auctioned. As indicated by arrow 17, a seller listed in database 15 may list an item for auction by causing the item to be listed in database 10. Bidders listed in database 14 place bids, indicated by arrow 18, which are accumulated in bid database 11.

It will be appreciated that the precise database structure of the online auction system 13 can vary and the particular design choices made do not affect the invention itself or its benefits. Stated differently, the invention offers many or all of its benefits regardless of the particular design choices made in system 13. For example, it may prove convenient to use a single database 16 to contain member identifiers, with each member able to serve as a bidder or seller or both depending on the particular item involved. Likewise databases 10 and 11 may be stored as a single database 12 within the system 13, although this is thought to be less preferable.

Sellers and bidders are, in a typical system 13, identified by unique identifiers called user IDs which serve as pointers into database 16. Items being auctioned are, in a typical system, identified by unique item numbers which serve as pointers into database 10 and optionally into database 11.

It will also be appreciated that the particular physical storage and computational facilities used in system 13 may be arranged in any of several ways as a matter of design decision by the designer of the system 13. In a very simple case a single computer and disk storage system can perform all the functions just discussed. In a large system with millions of users and millions of listed items, it is preferable to break up the many functions into separate physical parts. For example one server may serve as “front end” for web-interface visitors, while a second server may be devoted to serving up images and other items of data that change only slowly (e.g. item descriptions). Yet another server may collect bids while a fourth server may authenticate visitors who are logging into the system. Those skilled in the art will appreciate that as the system scales, other approaches may be taken to support bandwidth needs. Ten bid-related servers may divide up the task of receiving bids and keeping track of who is the highest bidder, each based upon the final digit of the item number, for example.

Those skilled in the relevant art will likewise be aware of standard approaches to system reliability, such as mirrored and striped RAID which improve fault tolerance and which reduce latency of disk accesses, all of which are omitted for clarity in FIG. 1.

Importantly, a bidder 21 who enjoys the benefits of the invention is communicatively coupled with the system 13 by means of link 25. The bidder 21 uses system 22 in an attempt to bid optimally, minimizing lost bidding opportunities. System 22 is, in an exemplary embodiment, a general-purpose personal computer running a suitable stored program, the computer located nearby to the user 21 and having a user interface 26 such as a keyboard, pointing device, and screen, and the computer connected by means of the Internet to the system 13. In this embodiment, which might be termed a “thick client” embodiment, there are typically as many personal computers (each providing system 22) as there are users 21.

In a second exemplary embodiment which might be termed an ASP (application service provider) or “thin client” embodiment, the system 22 is a server and the user interface 26 is a web-based interface. System 22 in this embodiment actually serves many users 21, each user having a respective user interface 26. It will be appreciated that there are advantages and disadvantages to these two approaches to providing the benefits of the invention to users 21, and it will also be appreciated that the invention can provide its benefits in embodiments differing from these two approaches, none of which depart in any way from the invention.

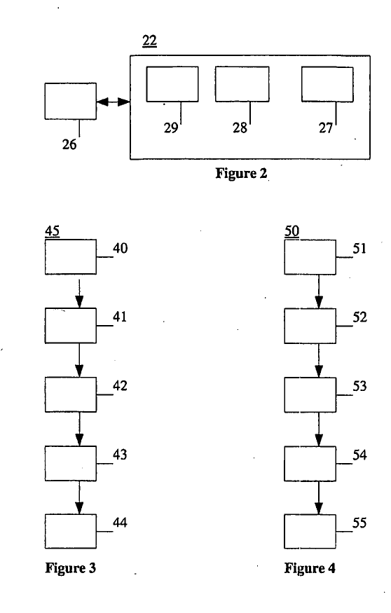

FIG. 2 shows apparatus 22 of FIG. 1 in greater detail, in functional block diagram form. User interface 26 is coupled with apparatus 22. Included in apparatus 22 is a database 29 of items of interest to the bidder 21, a database 28 of competing bidders, and a database 27 of search keys used for searching. The search keys from the database 27 are, as described below, used among other things to perform searches upon database 10 of items being auctioned. The database 28 of competing bidders will, in an exemplary embodiment, consist in large part of user IDs of such competing bidders, and are used to perform queries in system 13 to learn what items (if any) those competing bidders have bid on. Finally the database 29 of items of interest will, in an exemplary embodiment, consist in large part of item numbers, and are used to perform queries in system 13 to learn the status of items being auctioned.

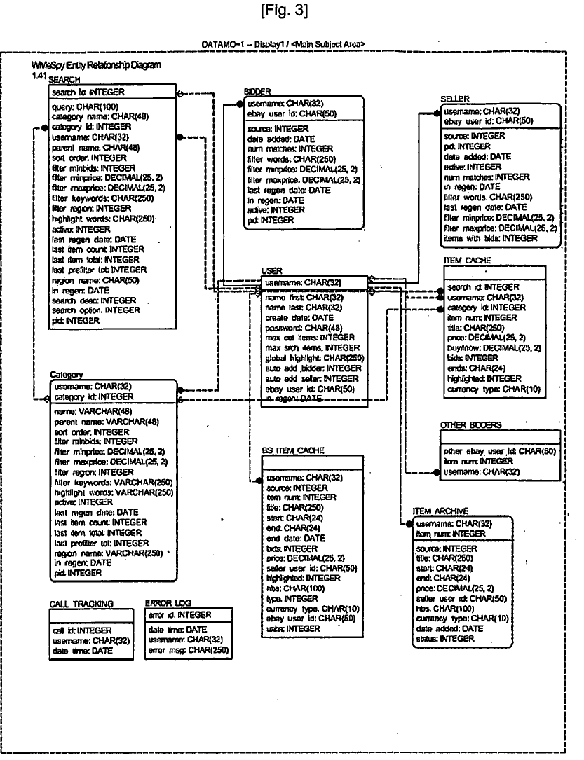

FIG. 3 shows in flowchart form a first method 45 according to the invention. By way of review this method 45 is carried out with respect to computer-based auction system 13, the auction system communicatively coupled 23, 24 with sellers 19 and bidders 20, the system 13 having records (in database 15) indicative of sellers of items and records (in database 14) indicative of bidders for the items and identifying for each item a winning bidder in an auction. At 40 a first bidder 21 selects a first item for which there is a winning bidder. In a simple case it is an item for which the winning bidder is not the same as the first bidder. (Alternatively this may be a case where the item is one where the first bidder was indeed the winning bidder, or may be a case where the item is simply one where the first bidder has placed a bid.)

Stated differently, in this simple case the user of the invention learns that he or she has lost an auction. The apparatus 22 then, in an automated way at box 41, obtains from system 13 information indicative of identities of second bidders other than the first bidder who previously placed respective bids for the first item. The identities of the second bidders are placed for example in database 28. The apparatus 22 then, in an automated way at box 42, finds second items other than the first item for which bids have been placed by one or more of the second bidders. The first bidder can then choose (at box 43) from among those second items, perhaps identifying an item that the first bidder had not previously found through previous searches of the kinds employed in the prior art. In a typical case the first bidder will not even learn of the existence of this item until after its auction has ended at which time it is too late to bid on it. It is not, however, too late to attempt to learn something from what happened. Thus the first bidder, can then (at box 44) attempt to discern why the first bidder was not aware of the second item until after the auction ended. This may include studying to see how this second item was classified by its seller; this may educate the user as to classifications that this seller, or other sellers, might choose to use in future for such items. This may also include studying to see the vocabulary that was selected by this seller, which may educate the user as to the vocabulary which this seller, or other sellers, might use in future. It may also be fruitful to take note of the seller's allocation of words as between the title and the description. If the user had previously searched for certain key words only in the title, and if such key words were seen (through this study) to turn up often in the description and not in the title (as one example) then the user could take this into account for future searches.

Consider, too, the case where a user did not fully appreciate ways in which sellers might misspell certain words in an item description. This study, in which a competing bidder somehow found the item despite the misspellings, might well assist the user in appreciating the possible benefit of searching using just such misspellings in future.

The learning opportunities provided in this way can benefit the user in at least two different ways. The user may, through more informed searching in future, come to learn of items that can be had at lower prices than items that would have been found through less effective searches. Or the user may learn of an item sooner, win it sooner, and enjoy its benefits sooner. Finally, for some unique items, such as collectables, there may be only one chance to obtain a given item and if the item is lost that may be the end of the matter.

FIG. 4 shows in flowchart form a second method 50 according to the invention. In this method, the user selects (at box 51) a first item of interest. This may for example be an item for which someone else was the winning bidder. Alternatively this may be an item that has an auction in progress, an item of interest to the user. The system 22 then (at box 52) obtains information indicative of identities of second bidders other than the first bidder who have already placed respective bids for the first item. The system 22 then (at box 53) finds second items other than the first item for which bids have been placed by one or more of the second bidders. The first bidder (at box 54) may then choose a second item for which the auction has not yet ended and for which the first bidder has not yet placed a bid. At box 55, the first bidder (user) places a bid electronically for the second item prior to the end of the action, the bid higher than any bid previously placed for the second item. Of course it is hoped that the user may in this way have the good fortune to win that auction. It will be appreciated that in this way the would-be bidder will have learned of some item available for bidding that the would-be bidder might well not have learned about through conventional searching techniques. Experience also shows that these approaches can save the human user hours of searching time as compared with previous methods of searching. To take up again the “photograph” example mentioned above, if a competing bidder has noticed the item of interest in the corner of the photograph, this approach may permit coming to learn of the item (and its reason for being interesting) in enough time to place a bid on the item.

Other benefits include the fact that this new information may save money for the bidder by permitting winning the present item for a lower price than some other comparable item for which the bids have risen (or will later rise) to a higher price. Alternatively this new information may enable the bidder to learn of, and purchase, an item right away, when a comparable item might not otherwise have come to the attention of the bidder (through conventional searching) until some later time. Finally, as mentioned above, this new information may permit finding and acquiring unique items that would otherwise be lost and for which there is no ready substitute.

One variant of the invention calls for “auto-adding” competing bidders. The user looks at items that other bidders are bidding on. The user looks at how frequently it has happened that some other bidder has bid on the same items that the user has bid on, and if some threshold is reached that other bidder will be added to a bidder list. Alternatively, such an other bidder can be manually added to the bidder list.

One way to think about the apparatus according to the invention is that it permits tracking and analyzing the actions of other participants in an auction system in order to locate items which might otherwise not have been found. The apparatus analyzes the similarities between the user and the other participants in the auction system.

It will be appreciated that while the chief benefits of the invention are thought to offer themselves in the context of an automated online auction system, these benefits may in some circumstances also offer themselves in auctions held in person, by proxy, or by any other medium.

The apparatus can allow the user to designate which categories (classifications) he or she typically browses when searching for items in an auction. These categories are entered into the system, perhaps by selecting them from a web-based menu or by entering in numerical classification values. The system keeps a current cache of items listed in these categories. This cache is updated at predefined intervals or as requested by the user. A set of user-defined filters may be applied to the results of this searching.

The apparatus can allow the user to define search terms. The system fetches all matching items from the auction system and saves them in a local database. Again, user-defined filters may be applied to the results of this searching.

The system can also allow the user to designate other auction participants that the user typically competes with in the bidding process. This is done by storing user IDs of those participants. The system then fetches all of the others items that these participants are bidding on. These items are stored in the aforementioned item cache.

The system can also allow the user to specify manually item numbers of items of interest. The system retrieves the status of such items from the auction system and makes this information available to the user.

The system can also look for all auctions which the user has bid on, and can retrieve the identifiers of all of the sellers for those items, as well as all of the competing bidders for those items.

As was mentioned above, the system desirably permits the user to set up filters so that not all of the retrieved items are displayed. Typical filters can be on maximum price, minimum price, geographic region, or items that have received fewer than some number of bids. A “filter-out” keyword can filter out items containing certain key words.

It is also desirable to be able to specify “highlight words” which are highlighted when an item is displayed. The highlighting can be by color, font, or other distinctive quality of text.

In an exemplary embodiment, the system will keep track of how often a particular bidder turns out to be a competing bidder. When this happens more than some pre-determined number of times (set by the user, or by default) then this bidder will be put into a list of “bidders to watch.” The system then automatically tracks everything that such a bidder bids on, and reports it to the user. The same can be done for sellers who turn up repeatedly among sellers of items of interest.

FIG. 5 depicts relationships among various data records in the system according to the invention, all of which are discussed in detail below. Reading down the first column on the left, there is a search entity, and below it a category entity. Call tracking and error logging records are shown, discussed below. Reading down the middle column, there are data records representing bidders. Below that is a data record rep-resenting a user of the system, and a data record called BS_ITEM_CACHE, rep-resenting a cache of items found by analysis of buyers and sellers. Reading down the right column are data records representing sellers, an item cache, data records indicative of other bidders, and an archive of items of interest.

Turning to the “category” database, it stores all the categories users of the site want items downloaded for. Its primary keys are Username and Category_id.

Username stores the username of the user storing this category. Category_id stores the auction system's unique identifier. The next few fields are:

Name: the text name of the category, according to the auction system it belongs to

Parent_name: the text name of the category's immediate parent. NULL if said category is top-level.

Sort_order: code that indicates how the items in the category should be sorted.

1: ending date

2: price ascending

3: price descending

4: title

5: # bids

Filter_minbids: minimum number of bids an item in this category must have in order to be displayed

Filter_minprice: minimum price an item must have in this category in order to be displayed

Filter_maxprice: maximum price an item may have in this category in order to be displayed

Filter_keywords: list of keywords the item must not include in order to be displayed

Filter_region: a region code the item must possess in order to be displayed in this category.

Highlight_words: a list of words that, if contained in the auction title, should be highlighted in some fashion.

Active: flag that tells the system whether or not to download items for this category.

1: active

0: inactive

Last regen_date: date and time at which the system last fetched items for this category.

Last_item_count: number of items downloaded from this category the last time the category was processed.

Last_item_total: number of items the auction system claimed were in this category last time the category was processed.

Region_name: the name of the region associated with the filter_region column.

In_regen: data and time at which the current regeneration process was started.

NULL indicates the category is not currently being processed.

Pid: process ID number the system assigned to the script that is processing this category. NULL indicates it is not currently being processed.

Turning to the “search” database (item 27 in FIG. 2), this stores all the search queries users want items downloaded for. Its primary key is “Search_id.” Fields include:

Search_id: unique id number automatically assigned by the database each time a new search term is added. Uniquely identifies each stored search query.

Query: the actual stored search query (text) to be sent to the auction system when searching for items.

Username: username of the site user that is storing the query.

Category_id: optionally, a user can specify a category to confine the search to.

Category_name: the textual name of the aforementioned category.

Parent_name: the name of the parent category of the aforementioned category_id.

NULL if category is top-level.

Sort_order: code that indicates how the items resulting from the query should be sorted.

1: ending date

2: price ascending

3: price descending

4: title

5: # bids

Filter_minbids: minimum number of bids an item resulting from the query must have in order to be displayed

Filter_minprice: minimum price an item resulting from the query must have in order to be displayed.

Filter_maxprice: maximum price an item resulting from the query may have in order to be displayed.

Filter_keywords: list of keywords the item must not include in order to be displayed

Filter_region: a region code the item must possess in order to be displayed in the query results.

Highlight_words: a list of words that, if contained in the auction title, should be highlighted in some fashion.

Active: flag that tells the system whether or not to download items for this stored search.

1: active

0: inactive

Last_regen_date: date and time at which the system last fetched items for this search.

Last_item_count: number of items downloaded from this search the last time the search was processed.

Last_item_total: number of items the auction system claimed resulted from the stored search last time the stored search was processed.

Last_prefilter_total: number of items the stored search yielded before server-side filtering took place.

Region_name: the textual name of the region if the region filter was specified above.

In_regen: date and time at which the current regeneration process started. NULL if search is not currently in regen.

Search_desc: flag that indicates whether auction descriptions should be searched in addition to titles. 1: search them. 0: don't.

Search_option: field to hold additional search options to be passed on to the auction provider.

Pid: process ID number the system assigned to the script that is processing this search. NULL indicates it is not currently being processed.

Turning now to the Bidder database—this is a table (item 28 in FIG. 2) that stores all of the other bidders being watched by users of the site. Its primary keys are the bidder Ebay_user_id and the Username. Fields include:

Ebay_user id: unique user identifier that the bidder uses on the outside auction system.

Username: unique user identifier of the user of this site.

Source: flag that indicates whether the site user or the system added this bidder to the database.

1: user added, 2: system added

date_added: date this bidder was added to the database.

Num_matches: the number of items the user of the site had in common with this bidder. IE: how many auctions did they both bid on.

Filter_words: list of words that, if present in the title of the auction, should be used to remove the item from the result set.

Filter_minprice: minimum price an item must have in order to be part of the result set from this bidder.

Filter_maxprice: maximum price an item may have in order to be part of the result set from this bidder.

Last_regen_date: date and time of the last successfully completed regeneration process for this bidder.

In_regen: date and time at which the current regeneration process started for this bidder. NULL indicates bidder is not being regenerated.

Active: flag to indicate to the system whether or not items should be downloaded for this bidder.

Pid: process ID number the system assigned to the script that is processing this bidder. NULL indicates it is not currently being processed.

The next database is the Seller file, a table that stores all of the other sellers being watched by users of the site. Its fields include:

Ebay_user_id

Username

Ebay_user_id: unique user identifier that the seller uses on the outside auction system.

Username: unique user identifier of the user of this site.

Source: flag that indicates whether the site user or the system added this seller to the database.

1: user added, 2: system added

date_added: date this seller was added to the database.

Num_matches: the number of items the user of the site had in common with this seller. IE: how many auctions did they both bid on.

Filter_words: list of words that, if present in the title of the auction, should be used to remove the item from the result set.

Filter_minprice: minimum price an item must have in order to be part of the result set from this seller.

Filter_maxprice: maximum price an item may have in order to be part of the result set from this seller.

Items_with_bids: flag to indicate to the system whether or not items being downloaded must have at least one bid on them. 1: only get items with bids, 0: doesn't matter.

Last_regen_date: date and time of the last successfully completed regeneration process for this seller.

In_regen: date and time at which the current regeneration process started for this seller. NULL indicates seller is not being regenerated.

Active: flag to indicate to the system whether or not items should be downloaded for this seller.

Pid: process ID number the system assigned to the script that is processing this seller. NULL indicates it is not currently being processed.

A next database is the Username database, containing all the user account information for users of the site. Fields include:

Username: unique alphanumeric identifier users of the site use to log in.

Name_first: first name of the registered user.

Name_last: last name of the registered user.

Create_date: date the user account was created.

Password: user's password, stored in hash format.

Max_cat_items: maximum number of items to be downloaded for each category, by the system, for this user.

Max_srch_items: maximum number of items to be downloaded for each stored search query, by the system, for this user.

Global_highlight: list of words that should be highlighted if encountered in an auction title.

Auto_add_bidder: numerical constant specified by the user to tell the system when another bidder should be auto-added to the bidder watch list.

Auto_add_seller: numerical constant specified by the user to tell the system when another seller should be auto-added to the seller watch list.

Ebay_user_id: stores the unique identifier (username) this user uses on other auction sites.

In_regen: stores the date and time at which the current regeneration process started.

A next database is the Item Cache database. This is a table that stores information about individual auctions that are downloaded as a result of the system browsing categories or running search queries for the user of the site. The contents of this table will change often—nothing is permanently stored. Fields include:

Username: unique alphanumeric identifier users of the site use to log in.

Category_id: unique identifier used by an outside auction system to identify a specific category.

Search_id: relates to a stored search query in our database.

Item_num: unique identifier used by an outside auction system to identify a specific auction item.

Title: title of the item up for auction.

Price: price of the item up for auction.

Buyitnow: if the item has a “buy it now” price, it is stored in this column.

Bids: number of bids currently on the item.

Ends: string that describes when the auction ends—can either be a date or a number of days/hours.

Highlighted: flag indicating whether this item should appear as “highlighted” in the result set. 1: highlight, 0: not highlighted.

Currency_type: indicates the type of currency the auction is using.

A next database is the buyer-seller cache. This is a table that stores information about individual auctions that are downloaded as a result of viewing the buying/selling habits of other auction system users. The contents of this table will change often—nothing is permanently stored. Fields include:

Username: unique alphanumeric identifier users of the site use to log in.

Item_num: unique identifier used by an outside auction system to identify a specific auction item.

Source: flag that indicates whether the system entered this auction item or the user did. 1: user, 2: system.

Title: title of the item up for auction.

Start: a string representing the date at which the auction was initially listed.

End: string that describes when the auction ends—can either be a date or a number of days/hours.

End_date: the ‘end’ column converted into a MYSQL date type—for better sorting.

Bids: number of bids currently on the item.

Price: price of the item up for auction.

Seller_user_id: the unique identifier the seller of the auction uses on the external auction system.

Highlighted: flag indicating whether this item should appear as “highlighted” in the result set. 1: highlight, 0: not highlighted.

Hbs: acronym for ‘highlighted bidder or seller’—will store the unique identifier of the high bidder of the auction or the marked seller.

Type: flag that indicates whether this item belongs to a bidder or a seller on the external auction system. 1: seller, 2: bidder.

Currency_type: indicates the type of currency the auction is using.

Ebay_user_id: the unique identifier the marked bidder or seller uses on the external auction system.

Uabs: multi-purpose flag column.

A next database is a database 29 of items of interest to the bidder 21. This is the item archive, a table that stores auction items that have been bid on, sold by, or specifically added by the user of the site. Items in this table are permanent and do not change very frequently. Fields include:

Username: unique alphanumeric identifier users of the site use to log in.

Item_num: unique identifier used by an outside auction system to identify a specific auction item.

Source: flag that indicates whether the system entered this auction item or the user did. 1: user, 2: system.

Title: title of the item up for auction.

Start: a string representing the date at which the auction was initially listed.

End: string that describes when the auction ends—can either be a date or a number of days/hours.

Price: price of the item up for auction.

Seller_user_id: the unique identifier the seller of the auction uses on the external auction system.

Hbs: acronym for ‘highlighted bidder or seller’—will store the unique identifier of the high bidder of the auction or the marked seller.

Currency_type: indicates the type of currency the auction is using.

Date_added: date and time at which this item was entered into the system.

Status: indicates the status of the auction:

0: auction still in progress

1: auction ended

A next database is the call tracking database, which is a table to log each time a call is made to eBay (page download) and what type of call it was Fields include:

Username: username of the system that was logged in and is responsible for the call being made.

Call_id: number that identifies what type of call was made:

1: category browse page

2: search results page

3: bidder items page

4: seller items page

date_time: the date and time at which the call was made to the external auction system.

Another database is the “other bidders” table, which keeps a running tally of which external auction users have bid on which items in the item_archive. Fields include:

Username: unique alphanumeric identifier users of the site use to log in.

Item_num: unique identifier used by an outside auction system to identify a specific auction item.

Other_ebay_user_id: the unique identifier the marked bidder or seller uses on the external auction system.

Finally there is an error log table, which stores system-generated and handled error exceptions. Fields include:

Error_id

Error_id: auto_incremented number assigned by the database every time a new error is logged.

Date_time: date and time at which the error was logged.

Username: username that was responsible for the handled error.

Error_msg: message detailing the error and how it was caused.

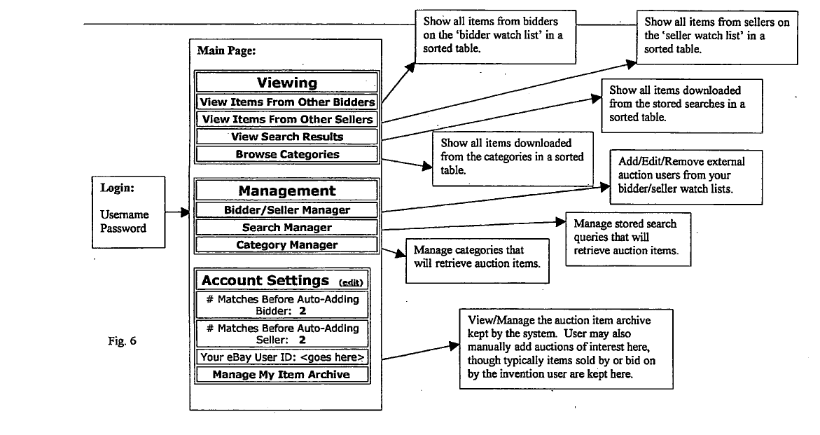

FIG. 6 shows a user interface flowchart for apparatus according to the invention. At left is a user login page. This leads to a main page from which the user can jump to any of several sub-pages. Buttons on the main page include “View Items From Other Bidders” which leads to a page which shows all items from bidders on the ‘bidder watch list’ in a sorted table. The next main-page button is “View Items From Other Sellers” which leads to a page which shows all items from sellers on the ‘seller watch list’ in a sorted table. The next main-page button is “View Search Results” which leads to a page which shows all items downloaded from the stored searches in a sorted table. The next main-page button is “Browse Categories” which leads to a page which shows all items downloaded from the categories in a sorted table. (Note that the term “categories” as used here corresponds to the “classifications” discussed above.)

Next on the main page is a “management” area. The first button here is “Bidder/Seller Manager” which permits the user to add, edit, or remove external auction users from the user's bidder/seller watch lists. Next is a “Search Manager” button which permits the user to manage stored search queries that will retrieve auction items. Next is a “Category Manager” button which permits the user to manage categories that will retrieve auction items.

Another button on the main page is “Manage My Items Archive.” This permits the user to view and manage the auction item archive kept by the system. User may also manually add auctions of interest here, though typically items sold by or bid on by the invention user are kept here.

Yet another part of the user interface is a button permitting the user to configure the number of matches that will trigger adding a competing bidder to one's list of competing bidders, or for adding a seller to a premier seller list.

It is helpful to describe an exemplary language platform, namely a computer server running web server software, such as the Apache web server. In this exemplary embodiment, the scripting language used for implementation of this service is PHP.

PHP is a widely-used general-purpose scripting language that is especially suited for Web development and can be embedded into HTML. The language also has a vast array of functions available that are tailored to downloading information in an efficient manner from the Internet. The apparatus according to the invention uses PHP not only to display information to the user dynamically through the web interface, but also as the scripting language of choice for gathering data from external auction sources on the Internet.

PHP is extremely fast and well-integrated to the Apache web server software. This makes for fast and efficient processing of data both inside and outside the current invention system.

The relational database management system (RDBMS) used in the preferred embodiment of the current invention is MYSQL (www.mysql.com). MySQL is a continually-evolving open-source software creation, meaning it benefits from the input of many contributors around the world. MySQL is particularly good at interfacing with the PHP scripting language for the purposes of storing and retrieving small or large amounts of data with relatively good speed and scalability.

A basic example of these two technologies, PHP and MySQL, being used together for the purposes of the current invention, is the process of storing values such as how many items are listed on a particular external auction service that match a particular search query.

The following code shows how data can be saved to the MySQL database, from within a PHP script, with only 2 lines of code, or 3 if you count the functionless comment line.

#tell database how many prefiltered items there were

$sql=“UPDATE ‘category’ SET ‘last_prefilter_total’=$prefilter_total WHERE ‘username’=‘$username’ AND ‘category_id’=$category_id”;

$result=mysql_query($sql,$db) or die(“UPDATE SQL Failed: $sql\n”);

It is instructive to discuss some of the inner workings of an ASP embodiment of the apparatus according to the invention. The apparatus requests, receives, parses, and consequently stores auction data related to a category on the eBay auction system. What follows is one example of the many different types of auction data that can be downloaded. Using the PHP programming language, a function called ‘browseCategory’ is defined for the purpose of downloading and parsing auction data based on a category ID number passed into the function.

First, the filters are retrieved from the MySQL database that are associated with this category for the particular user that is currently logged in. The username logged in is globally known because it is part of the session's data.

```
  #look up filters for this category
  $sql = “SELECT
\grave{ }sort_order\grave{ },\grave{ }filter_minbids\grave{ },\grave{ }filter_minprice\grave{ },\grave{ }filter_maxprice\grave{ },
\grave{ }filter_keywords\grave{ },\grave{ }filter_region\grave{ },\grave{ }highlight_words\grave{ }”;
  $sql = $sql. “ FROM \grave{ }category\grave{ } WHERE \grave{ }category_id\grave{ } =
$category_id AND \grave{ }username\grave{ } = ‘$username’”;
  $result = mysql_query($sql,$db);
  $myrow = mysql_fetch_array($result);
  $sort_order = $myrow[“sort_order”];
  $filter_minbids = $myrow[“filter_minbids”];
  $filter_minprice = $myrow[“filter_minprice”];
  $filter_maxprice = $myrow[“filter_maxprice”];
  $filter_keywords = $myrow[“filter_keywords”];
  $filter_region = $myrow[“filter_region”];
  $highlight_words = $myrow[“highlight_words”];
  if ($filter_minprice == “0.00”) {
  $filter_minprice = “”;
  }
  if ($filter_maxprice == “0.00”) {
  $filter_maxprice = “”;
  }
```

Once the filters have been retrieved and stored in local variables, a URL must be generated to send as a page request to eBay.

This is done by embedding the category number into a pre-defined eBay URL template:

#prepare url

$url=‘/aw/plistings/list/all/category’. $category_id. ‘/index.html’;

$url=$url. “?region=$filter_region”;

Now, a loop is initiated which will generate all the necessary URLs to be sent to eBay.

while ($next_link !=“ ” and $pages_done <$max_pages) {

$next_link=‘http://listings.ebay.com’. $next_ink;

Inside this loop, each page is fetched via an HTTP call and broken down into its separate tables by a function called page2tables.

#break page down into all its tables

$tmp_tables=page2tables($next_ink, $indicator, 1, $first1page, $saved_line_ptr);

Page2tables is passed a string called an ‘indicator’, which tells the function what text to look for that should indicate that a group of 5-celled item tables are coming soon. In the current case of browsing category results, the string “items found” indicates that the very next table encountered in the HTML will be an item table, so we will capture its data!

#this indicator lets us know that the next table after this one will be an item table

$indicator=“items found”;

After all of the links have been generated, sent to eBay, and downloaded, the specific auction data needs to be parsed out, cleaned up, and stored in the database.

A function called tables2items does this and stores the results in an item_array, which is a multi-dimensional associative array used to stored multiple auction listings and all of the data associated with each auction in an organized fashion.

#turn tables into ebay items

$item_array=tables2items($tables);

Quoted below is exemplary code used to parse the tables from eBay pages into clean auction data. This section of code happens to be specific to the eBay service and will only work on that service. The routine only processes a table from eBay if the table had 5 cells, a characteristic unique to item-holding tables. It uses regular expression functions to split apart strings and parse out the valuable data.

#extract search results from the tables
foreach ($tables as $table) {
$this_num_cells = sizeof($table);
#only read this table if it has 5 cells (like an item)
if ($this_num_cells == 5) {
$cell_num = 0;
foreach ($table as $cell) {
switch ($cell_num) {
case 0:
#item_num
$cell = strip_tags($cell);
#item number may not be in this cell all the time
if ($cell == “”) {
$get_item_num = 1;
}
else {
$item_array[‘item_num’][$item_cnt] = $cell;
}
$cell_num++;
break;
case 1:
#get item number from href tag if need be
if ($get_item_num == 1) {
$data = split(“item=”,$cell);
$data2 = split(‘‘’>’,$data[1]);
$item_num = $data2[0];
#11-22-2002 - &category is showing up in item num, strip it out
$data = split(“&”,$item_num);
$item_num = $data[0];
##
$item_array[‘item_num’][$item_cnt] = $item_num;
$get_item_num = 0;
}
#title and icons (ignoring icons currently)
$cell = strip_tags($cell);
$cell = str_replace(“‘”,“””,$cell);
$item_array[‘title’][$item_cnt] = $cell;
$cell_num++;
break;
case 2:
#price
$cell = strip_tags($cell);
$data = “”;
$currency_type = “”;
#7-24-2002 ebay included the buy-it-now price in the same field
#look like: $30.00$40.00 or GBP 12.00 or GBP 4.00GBP 12.00
if (stristr($cell,‘$’) and !stristr($cell,‘C’) and !stristr($cell,‘AU’)) {
#split on $ if it has a $ (not canadian or AU)
$data = preg_split(‘Λ$/’,$cell);
}
elseif (stristr($cell,‘$’) and stristr($cell,‘C’)) {
#canadian money
$currency_type = “C”;
$data = split(“C ”,$cell);
$data[1] = str_replace(‘$’,”,$data[1]);
$data[2] = str_replace(‘$’,”,$data[2]);
}
elseif (stristr($cell,‘$’) and stristr($cell,‘AU’)) {
#australian money
#AU $2.00AU $4.95
$currency_type = “AU”;
$data = split(“AU ”,$cell);
$data[1] = str_replace(‘$’,”,$data[1]);
$data[2] = str_replace(‘$’,”,$data[2]);
} elseif (stristr($cell,‘GBP’)) {
#british money
$currency_type = “GBP”;
#GBP 4.00GBP 12.00
#must split on GBP
$data = preg_split(‘/GBP /’,$cell);
} elseif (stristr($cell,‘EUR’)) {
#euro money
$currency_type = “EUR”;
#GBP 4.00GBP 12.00
#must split on GBP
$data = preg_split(‘/EUR /’,$cell);
}
$item_array[‘price’][$item_cnt] = str_replace(‘,’,”,$data[1]);
$item_array[‘buyitnow’][$item_cnt] = str_replace(‘,’,”,$data[2]);
$item_array[‘currency_type’][$item_cnt] = $currency_type;
$cell_num++;
break;
case 3:
#bids
$cell = strip_tags($cell);
$item_array[‘bids’][$item_cnt] = $cell;
$cell_num++;
break;
case 4:
#ends
$cell = strip_tags($cell);
$item_array[‘ends’][$item_cnt] = $cell;
$cell_num++;
break;
}
}
$item_cnt++;
}
}
}

After the item_array of eBay auction items is returned to the browseCategory function, the filters predefined for this particular category by this particular user are applied. The same regular expression and string comparison tactics are used in this process as well. Once a final array of items is created that has passed the filters and that has been appropriately highlighted, based on the predefined ‘highlight words’, it is returned to the calling script, in this case, the regeneration script for categories.

The regeneration script itself then loops through the array of eBay items and inserts the data into the MySQL database.

If, at any point in this process, an error occurs, such as a page from eBay is downloaded and found to be incomplete, or code is not where it was expected to be, an error message is generated and logged.

The error message will indicate what line of code the exception occurred, what the session variables were at the time of the error, and what some of the circumstances were, regarding eBay, at the time of the error. All of this information is invaluable when tracking down a bug or when compensating for changes on eBay's end of the operation.

Having discussed some of the system design issues, it is instructive to discuss how threads are spawned to handle the many tasks required to serve the user well. This involves an account of the allocation of tasks to foreground and background.

The following “pseudo code” describes how scripts for regenerating databases are brokered, queued, and launched in order to download items from the external auction service for the users of this invention.

It should be noted that the term “regeneration” or “regen” refers to the process of the invention making HTTP requests to the external auction service, receiving raw HTML back, parsing the HTML, applying filters and highlights, and saving the auction data in the local database. This process can be scheduled to run at any given interval or can be done upon user login.

Main Page Tasks:

Fetch total number of system threads allocated to the application (stored in a config file) (max_threads.

Determine how many threads this particular user may use to regenerate auction data.

max_threads_for_user=max_threads/num_users_online

Script launching routine:

Bidders: # of threads to spawn for regeneration of bidder data=the number of bidders that need to be refreshed/a numerical constant (ie: 4) update the value of threads_left (threads available for the spawning of other processes) (threads_left=threads_left−bidders_launched

Sellers: # of threads to spawn for regeneration of seller data=the number of sellers that need to be refreshed/a numerical constant (ie: 4) update the value of threads_left (threads available for the spawning of other processes) (threads_left=threads_left−sellers_launched

Searches: launch as many seller regen scripts as needed or as possible, provided the “threads_left” value is not 0.

Categories: launch as many category regen scripts as needed or as possible, provided the “threads_left” value is not 0.

This process, carried out by the main page upon initial log in of the system user, gives specific priority first to the bidders and then to sellers, because they normally complete quickly. After those two groups are done, the more time-consuming searches and categories may consume system resources. This is done to maximize system efficiency and give the user something to look at (bidder and seller items) while the more resource-intensive tasks are being carried out.

Once these regeneration scripts are launched from the main page upon initial log-in, the user may stray from the main page and not worry about the tasks that need to be completed. The scripts will call each other upon completing, in order to keep making progress, as described in the pseudo code below. When displayed, however, the main page will refresh regularly to let the user know how the process of regeneration is coming along. For instance, the main page may say something to the effect of:

“Currently Fetching Data for 10 Categories. 15 are waiting in Queue and 25 are ready for viewing.”

Background Script Processing:

Regeneration Script Tasks:

There are four different types of regeneration scripts—one for bidders, one for sellers, one for searches, and one for categories. They all take the basic form of the logic outlined in the following pseudo code. Their main differences are the sections of the external auction site in which they query, and how/where they store the data that comes back from the external sources.

<regen start>

this_pid=obtain system PID number this process is currently using.

While the life time of the script is less than predefined constant (ie: 15 minutes), do the following tasks:

obtain an external auction site username from the database that still needs to be regenerated.

if one does not exist, continue to final routine of the script.

otherwise, do the following steps:

let the database know that this instance of the regen script is claiming responsibility for the external auction site username obtained from the database, using the aforementioned PID (this_pid).

Check to see if this_pid is the PID on record in the database for this external auction site user_id.

If so, we have successfully locked the row, so continue to download items for this user or category.

Otherwise, go back to step one and fetch another name to try the process again.

Once looping is finished and all the items for this particular bidder/seller/category/search have been downloaded, check to see if there are other bidders/sellers/searches/categories to be regenerated by using the exact same logic outlined in steps 1-3 of Main Page Logic (above).

After doing the check and spawning a new process (if needed), terminate gracefully.

Those skilled in the relevant art will have no difficulty whatsoever devising myriad obvious variants and improvements to the invention, all of which are intended to be embraced within the claims which follow.

1-4. (canceled)

5. A method for use with a bidding apparatus including a computer, a computer-based auction system, the auction system communicatively coupled with sellers and bidders, the system having records indicative of sellers of items and records indicative of bidders for the items and identifying for each item a winning bidder in an auction, the method comprising the steps, performed by a first bidder, of: by the first bidder, selecting a first item; by the computer, obtaining information indicative of identities of second bidders other than the first bidder who previously placed respective bids for the first item; by the computer, finding second items other than the first item for which bids have been placed by one or more of the second bidders; by the first bidder, choosing a second item for which the auction has not yet ended and for which the first bidder has not yet placed a bid; and by the first bidder, placing a bid for the second item prior to the end of the auction, the bid higher than any bid previously placed for the second item.

6. The method of claim 5 wherein the second bidders comprise all other bidders who previously placed respective bids for the first item.

7. The method of claim 5 wherein the second bidders comprise more than one and less than all other bidders who previously placed respective bids for the first item.

8. The method of claim 5 further comprising the step of: by the first bidder, winning the auction.

9-17. (canceled)

18. A method for use with a bidding apparatus including a computer, a computer-based auction system, the auction system communicatively coupled with sellers and bidders, the system having records indicative of sellers of items and records indicative of bidders for the items and identifying for each item a winning bidder in an auction, the method comprising the steps of: by the searcher, selecting a first item; by the computer, obtaining information indicative of identities of second bidders other than the first bidder who previously placed respective bids for the first item; by the computer, finding second items other than the first item for which bids have been placed by one or more of the second bidders; by the searcher, communicating the second items to a first bidder; by the first bidder, choosing a second item for which the auction has not yet ended and for which the first bidder has not yet placed a bid; and by the first bidder, placing a bid for the second item prior to the end of the auction, the bid higher than any bid previously placed for the second item.

19. The method of claim 18 further comprising the step of: by the first bidder, winning the auction.

20. A method for use with a bidding apparatus including a computer, a computer-based auction system, the auction system communicatively coupled with sellers and bidders, the system having records indicative of sellers of items and records indicative of bidders for the items and identifying for each item a winning bidder in an auction, the method comprising the steps of: for a user, identifying instances of a bidder bidding on an item that the user has bid on; if the number of such instances exceeds a predetermined threshold, adding that bidder to a list of bidders of interest.

21. The method of claim 20 further comprising the step, performed by the user, of manually adding a bidder to the list of bidders of interest.

22. The method of claim 20 further comprising the steps of: identifying by the computer, items for which an auction is pending, upon which one or more of the bidders from the list has bid; and by the user, bidding upon one of the identified items.

23. A method for use with a bidding apparatus including a computer, a computer-based auction system, the auction system communicatively coupled with sellers and bidders, the system having records indicative of sellers of items and records indicative of bidders for the items and identifying for each item a winning bidder in an auction, the method comprising the steps of: for a user, identifying instances of a seller offering an item that the user has bid on; if the number of such instances exceeds a predetermined threshold, adding that seller to a list of sellers of interest.

24. The method of claim 23 further comprising the step, performed by the user, of manually adding a seller to the list of sellers of interest.

25. The method of claim 23 further comprising the steps of: identifying by the computer, items for which an auction is pending, for which the seller is one of the sellers from the list; and by the user, bidding upon one of the identified items.
